(19) United States
(12) Patent Application Publication
(10) Pub. No.: US 2006/0230495 A1
(43) Pub. Date: Oct. 19, 2006

(54) Radiation protection material

(75) Inventors: Axel Thiess, Dusseldorf (DE); Ah Kiew Wong, Selangor (MY)

Correspondence Address: OLSON & HIERL, LTD., 20 NORTH WACKER DRIVE, 36TH FLOOR, CHICAGO, IL, 60606, US

(73) Assignee: Wembley Rubber Products

(21) Appl. No.: 11/273,573

(22) Filed: Nov. 14, 2005

Related U.S. Application Data
(63) Continuation-in-part of application No. 10/603,305, filed on Jun. 25, 2003, now abandoned.

(51) Int. Cl. A41D 19/015; B32B 27/18

(52) U.S. Cl. 2/167; 428/328; 428/339; 428/532; 428/521; 2/168

(57) ABSTRACT

A lead-free radiation protection material for use in radiation protection gloves to protect the wearer from scattered secondary radiation comprises at least one layer of a polymeric latex having lead-free radiation absorbing particles and a water soluble polymeric thickener distributed therein. The radiation absorbing particles are lead-free and have a particle size of less than about 10 μm, and comprise at least one lead-free heavy metal, heavy metal oxide or a combination thereof. The particles are dispersed within the latex at a concentration, by dry weight, sufficient for a sheet having a thickness of about 0.3 mm to block at least about 30% of scattered secondary X-radiation at an intensity of about 60 kV and at least about 20% of scattered secondary X-radiation at an intensity of about 100 kV.

### CROSS-REFERENCE TO RELATED APPLICATIONS

This application is a continuation-in-part of U.S. application for patent application Ser. No. 10/603,305, filed on Jun. 25, 2003, which is incorporated herein by reference.

### TECHNICAL FIELD OF THE INVENTION

The invention concerns a radiation protection material, especially suitable for use in radiation protection gloves, and processes for the manufacture of radiation protection gloves therewith.

### BACKGROUND OF THE INVENTION

Various medical procedures require physicians and other personnel to work in areas prone to electromagnetic radiation exposure, to include exposure to X-rays, gamma-rays, and other types of radiation. For example, during many diagnostic, detection and guidance procedures, surgeons and other medical staff may work in a field of operation that is irradiated with X-rays to allow for the use of a fluoroscopic viewing screen. These personnel are thus exposed to doses of radiation that may exceed acceptable safety levels or to long-term exposure of low dosage level radiation. Radiation exposure, even to low levels of X-rays, is known to produce a number of detrimental side effects. Medical personnel who work with X-rays and X-ray equipment thus require protection from such radiation exposure with protective garments or gloves that limit or attenuate the amounts of radiation received.

Accordingly, radiation protection garments that shield specific areas of the body sensitive to such radiation exposure are well known in the art. Such garments typically include coats, aprons, gloves and various shields having radiation absorbent materials therein to attenuate the radiation. The materials used to make such garments have been made from polymer mixtures having radiation attenuating materials mixed therein. The radiation attenuating materials of prior art mixtures have comprised lead, lead oxide, or other lead salts. Such attenuating materials were used, for example, in U.S. Pat. No. 3,185,751.

U.S. Pat. No. 3,185,751, which issued to S. D. Sutton on May 25, 1965 (“the Sutton patent”), is for the manufacture of latices, dispersions and compounds of polymeric organic material containing metal. The radiation protection material of this patent, which is used to make radiation protection gloves, comprises a middle layer of natural rubber latex containing lead particles arranged therein to attenuate the radiation intensity of scattered X-rays. The layer is formed by dipping a shaped former into a solution of matrix material followed by vulcanization of the formed material. This layer is then covered on both sides with additional layers of material not having lead particles therein.

Although the lead particles of the Sutton patent proved effective in attenuating radiation, it has been found that lead powder promotes vulcanization of a natural rubber latex composition in the liquid state before it has hardened. Thus, such a latex composition having a relatively high lead content, cannot be used for the continuous production of radiation protection gloves, as the matrix solution containing lead particles rapidly deteriorates and becomes unusable. Furthermore, the processing of lead is fundamentally undesirable for health reasons due to the fact that lead compounds are toxic materials. This toxicity may impose additional costs on the manufacture and/or user of such materials due to the required compliance with regulations relating to their handling and disposal.

Thus, there is a need for an invention that avoids the foregoing disadvantages. This invention thus arises from the task of finding a radiation protection material that is lead-free and in which radiation absorbing particles can be extremely homogeneously distributed.

### SUMMARY OF THE INVENTION

The invention provides for a lead-free radiation protection material comprising a polymeric latex material having radiation absorbing or attenuating particles distributed therein. The polymeric latex dispersion also comprises a water-soluble polymeric thickener at a concentration selected to minimize sedimentation of the radiation absorbing particles during a continuous glove manufacturing process. The radiation absorbing particles in the material are lead-free and consist essentially of at least one lead-free heavy metal, at least one lead-free heavy metal oxide, or a combination thereof. The radiation absorbing particles have a particle size of less than about 10 μm and are dispersed within the latex at a concentration, by dry weight, sufficient for a sheet of the material having a thickness of about 0.3 mm to block at least about 30% of scattered secondary X-radiation at an intensity of about 60 kV and at least about 20% of scattered secondary X-radiation at an intensity of about 100 kV.

The radiation protection material can be manufactured from a formulated aqueous dispersion of polymeric materials having radiation absorbing particles dispersed therein. In one embodiment of the invention, the radiation protection material can be formed into radiation protection gloves and may comprise natural rubber latex, radiation absorbing particles, and a polymeric thickener, such as a cellulose derivative, which by increasing the viscosity of the matrix material effectively reduces the speed of sedimentation of the radiation absorbing particles suspended therein, thereby enabling such gloves to be manufactured by a dipping process.

Commercially available pre-vulcanized natural rubber latex, commonly known as PV, is particularly suitable for manufacturing these radiation protection gloves as it is found to have exceptionally high latex stability and can accept a high loading of up to about twice its weight of radiation protection material without the latex dispersion undergoing premature coagulation. The resulting gloves of the invention formed from this latex dispersion also have adequate mechanical strength and physical properties. Radiation protection gloves of the invention, which are lead-free, comprise at least one layer of material, with multiple layers being successively formed. The radiation adsorbing particles distributed within the radiation protection material of the gloves can comprise particles of metallic tin, tin-oxide, antimony-tin oxide, bismuth oxide, tungsten oxide, or mixtures of the same. The minute particle size of these radiation absorbing particles are particularly suitable for homogeneous dispersal within the material because, as a given particle size becomes more fine, it has a slower rate of sedimentation within the matrix material.

The radiation protection material is shaped by dipping a form or pattern, e.g. a hand pattern, into coagulant and then into a formulated latex dispersion in a through-flow bath. Leaching, drying and preliminary finishing operations such as beading or trimming then follow. The latex products may be vulcanized in circulating hot air, steam, or hot water. Dipping, followed by vulcanization can be repeated several times, if desired, with finishing operations to include washing and drying.

### BRIEF DESCRIPTION OF THE DRAWINGS

In the drawings:

FIG. 1 is a top view of a radiation protection glove made of one embodiment of the radiation protective material; and

FIG. 2 is a sectional view showing at least one layer of the radiation protection material of the glove;

FIG. 3 is a flow chart of one embodiment of the process of making radiation protection gloves using the radiation protection material; and

FIG. 4 is a flow chart showing one embodiment of the post treatment process of the radiation protection gloves made of the radiation protection material.

### DESCRIPTION OF PREFERRED EMBODIMENTS

The invention provides a lead-free radiation protection material made of at least one layer of a polymeric latex having radiation absorbing or attenuating particles and a suitable polymeric thickener (e.g., a cellulose derivative) distributed therein. All of the radiation absorbing particles in the material are lead-free and consisting essentially of at least one lead-free heavy metal, at least one lead-free heavy metal oxide, or a combination thereof. The radiation absorbing particles have a particle size of less than about 10 μm and are dispersed within the latex at a concentration, by dry weight, sufficient for a sheet of the material having a thickness of about 0.3 mm to block at least about 30% of scattered secondary X-radiation at an intensity of about 60 kV and at least about 20% of scattered secondary X-radiation at an intensity of about 100 kV.

As used herein, the term “lead-free heavy metal” refers to any non-radioactive metallic element from period 4 or higher in the Periodic Table of the Elements, excluding lead. Preferred heavy metals include bismuth (Bi), tungsten (W), antimony (Sb) and tine (Sn).

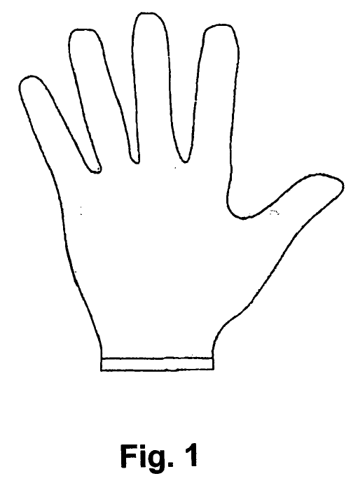

Preferably, the at least one layer of polymeric latex comprises about 20% to 40% by dry weight of rubber and about 60% to 80% by dry weight of radiation absorbing particles dispersed therein, more preferably about 33% by dry weight of rubber and about 67% by dry weight of radiation absorbing particles. In one embodiment of the invention, the radiation protection material can be formed into radiation protection gloves, as shown in FIG. 1. The polymeric material may be a rubber material made from polyisoprene rubber, (both natural and synthetic), polybutadiene rubber, styrene-butadiene rubber, nitrile rubber, butyl rubber, ethylene-propylene rubber, neoprene rubber, silicone rubber, polysulfide rubber, urethane rubber, a blend of such substances, or other similar substances.

In the preferred embodiment of the invention, natural rubber latex, a type of polyisoprene rubber produced naturally from rubber trees, is used. The natural rubber latex may contain the usual compounding ingredients such as surfactants, vulcanizing agents, activators, accelerators, antioxidants, pigments, antifoam agents and pH regulators, or any combination thereof in conventional amounts as needed to make gloves with the desired mechanical strength. Preference is given to the use of a commercially available ammoniac pre-vulcanized (PV) natural rubber latex where the preferred pH-value of this PV latex is greater than about 7, preferably about 10 to 11. The dry rubber content of this PV latex is about 50 to 70% by weight, preferably about 60% by weight, with an ammonia content between about 0.4 and 0.8% by weight, preferably about 0.6% by weight.

In addition to the radiation absorbing particles, the formulated latex dispersion may also contain a water soluble polymeric thickener, such as a cellulose derivative (e.g., methylcellulose, or a cellulose ether). Such water soluble polymeric thickeners are typically available in powder and granular forms, and increase the viscosity of the formulated latex dispersion when dissolved, thereby reducing the sedimentation rate of the radiation absorbing particles dispersed therein. In this way, the heavy radiation absorbing particles can be held in suspension and distributed uniformly within the formulated latex dispersion. The concentration of the thickener will depend on the particular thickener utilized. The concentration is selected so as to minimize sedimentation of the radiation absorbing particles from the formulated latex dispersion during the dipping process. In the case of metholose, the at least one layer of polymeric latex preferably comprises about 0.1 to 0.4% by dry weight, more preferably about 0.25% by dry weight.

In another embodiment of the formulated latex dispersion, natural rubber latex is used and 200 parts by dry weight of radiation absorbing particles are added to this latex containing 100 parts by dry weight of rubber (phr) and the usual compounding ingredients. The radiation absorbing particles are added to this latex in the form of a liquid dispersion, which in turn is prepared beforehand by ball-milling a typical composition as shown in Table 1.

TABLE 1
RADIATION ABSORBING PARTICLE
DISPERSION FORMULATION

| Material | | Pbw (dry) | Wet Weight (Kg) |
|---|---|---|---|
| 100% | Radiation Absorbing Particle | 100.00 | 100.00 |
| 20% | Teric | 0.20 | 1.00 |
| 3% | Metholose | 0.10 | 3.33 |
| 3% | Latekoll D | 0.24 | 8.00 |
| | Deionized Water | — | 23.53 |
| | Total | 100.54 | 135.86 |

The typical properties of this dispersion as added to the latex compound are shown in Table 2.

TABLE 2
TYPICAL RADIATION ABSORBING PARTICLE
DISPERSION PROPERTIES

| | |
|---|---|
| TSC % | 72.0-76.0 |
| pH | Min 9.0 |
| Viscosity (cps), Spindle 3 @ 30 rpm | Min 900 |

This high mix proportion of the radiation absorbing particles to the latex dispersion is made possible by the addition of the water soluble polymeric thickener (methylcellulose), which by increasing the viscosity of the material mixture, reduces the sedimentation speed of the radiation absorbing particles to ensure a homogeneous distribution of the radiation absorbing particles within the latex. In a preferred embodiment of the radiation protection material of the invention, the composition of materials using pre-vulcanized natural rubber latex is as shown in Table 3.

TABLE 3
RADIATION LATEX COMPOUND FORMULATION BASED
ON PRE-VULCANIZED NATURAL RUBBER LATEX

| Material | | Phr | Wet Weight (Kg) |
|---|---|---|---|
| 60% | Pre-vulcanized Natural | 100.00 | 166.67 |
| | Rubber Latex (PV) | | |
| 20% | Emulvin W | 0.10 | 0.50 |
| 24% | Black Pigment | 0.012 | 0.05 |
| 74% | Radiation Absorbing particle | 200.00 | 270.27 |
| 100% | Coagulant WS | 0.20 | 0.20 |
| 3% | Metholose | 0.50 | 16.67 |
| | Deionized Water | — | 46.99 |
| | Total | 300.812 | 501.35 |

The physical properties of this material mixture, as used to produce gloves by a dipping process, are shown in Table 4.

TABLE 4
TYPICAL RADIATION LATEX COMPOUND PROPERTIES

| | |
|---|---|
| TSC % | 56.0-62.0 |
| pH | Min 9.0 |
| Viscosity (cps), Spindle 3 @ 30 rpm | 300-500 |

We have found that commercial pre-vulcanized (PV) natural rubber latex has an unusually high latex stability, which makes it possible to accept a high loading of up to twice its dry rubber weight of radiation absorbing particles without affecting the overall colloidal stability of the formulated latex dispersion, i.e. avoiding premature coagulation. In this way, a highly homogeneous distribution of the particles is achievable with high reproducibility over extended period of time, which makes it possible to mass produce radiation protection gloves by a continuous dipping process.

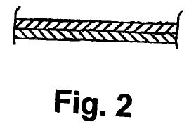

Turning to FIG. 2, the radiation protection material is lead-free and comprises at least one layer of latex having radiation absorbing particles dispersed therein, with multiple layers being successively formed. The radiation protection glove can be made up of one, two or more than two layers. In the preferred embodiment of the invention, one layer is used if the final material thickness is about 0.3 mm or less. For material thicknesses of above 0.3 mm, two or more layers are used.

The radiation absorbing particles utilized in the radiation protection materials of the invention are all lead-free and can comprise bismuth oxide alone or in combination with tungsten oxide, antimony-tin oxide and/or metallic tin. In one preferred embodiment, the radiation absorbing particles comprise about 60 to 90% by weight of metallic tin powder and about 10 to 40% by weight of bismuth oxide particles. Alternatively, the radiation absorbing particles can comprise about 60 to 90% by weight of tin oxide particles or antimony-tin oxide particles and about 10 to 40% by weight of tungsten oxide particles.

In another embodiment, the radiation absorbing particles comprise about 40 to 60% by weight of bismuth oxide particles and about 40 to 60% by weight of tungsten oxide particles. In yet a further embodiment, the radiation absorbing particles can comprise about 40 to 60% by weight of tin oxide particles or antimony-tin oxide particles, about 20 to 30% by weight of tungsten oxide particles and about 20 to 30% by weight of bismuth oxide particles.

Alternatively, the radiation absorbing particles can comprise about 60 to 90% by weight of tin oxide particles or antimony-tin oxide particles and about 10 to 40% by weight of bismuth oxide particles.

Other embodiments can utilize 100% of a single composition of radiation absorbing particles instead of the above percentage combinations. According to these other embodiments, the radiation absorbing particles may be comprised entirely of bismuth oxide particles, tungsten oxide particles, tin oxide particles or antimony-tin oxide particles.

The particle size of all the radiation absorbing particles (tin, tin oxide, antimony-tin oxide, bismuth oxide, tungsten oxide) are less than about 10 μm, preferably less than about 6 μm. Such particles in the micrometer size range are particularly suitable for homogeneous dispersal in the latex dispersion. Because of their minute particle size, these radiation absorbing particles exhibit an especially low sedimentation speed. Furthermore, radiation-absorbing particles with a particle size under about 2 μm, preferably under about 1 μm are preferred.

The radiation protection gloves can be made by dipping processes. These processes include simple straight dipping where one or more coats of the latex dispersion are applied with no coagulant being used, as well as the coagulant dip processes, where a form is first dipped into coagulant and then into the latex dispersion. Commonly used coagulants include calcium chloride, calcium nitrate, zinc nitrate, and acetic acid.

In the preferred embodiment using the coagulant dip process, the radiation protection material is shaped by dipping a form or pattern, e.g. a hand pattern, into coagulant and then into a formulated latex dispersion in a through-flow bath. The latex dispersion is typically contained in a dipping tank provided with mechanical agitation and a temperature controlled jacket. The form is usually made from a ceramic material, but can alternatively be made of aluminum, stainless steel, or any other suitable material. The form can be dipped by manual control or automatic operation. It is important to have uniformity in the rates of immersion and withdrawal of the form. Care must be taken to avoid trapping air in the layer of latex deposited on the surface of the form, which can cause pinholes and/or blisters. After withdrawal of the form, the flow of deposited latex can be controlled in many ways, but is generally controlled by rotating the form to ensure an even distribution of the deposited latex.

Leaching, drying and preliminary finishing operations such as beading or trimming then follow. The latex products may be vulcanized in circulating hot air, steam, or hot water. If vulcanized with hot air, the vulcanization process takes place in a through-flow oven. It is noted that vulcanization may take place on or off the form. If cured on the form, dipping followed by vulcanization can be repeated several times. The formed articles may be stripped wet or dry. Finishing operations include washing and drying.

In the preferred embodiment, an aqueous dispersion of the fine radiation absorbing particles is first prepared by grinding the a radiation absorbing material in an aqueous solvent (about 75% concentration) in a ball-mill. This dispersion is then added slowly into a pre-vulcanized latex emulsion (containing the rubber) with constant stirring preferably at room temperature to yield a uniform liquid compound mixture as in normal latex compounding. The latex compound mixture essentially now contains a colloidal suspension of the submicron radiation absorbing particles being non-agglomerated and uniformly dispersed. A preferred radiation protection glove comprises two lead-free layers, as illustrated in FIG. 2, that are successively formed using a matrix material compound having the composition set forth in Table 3.

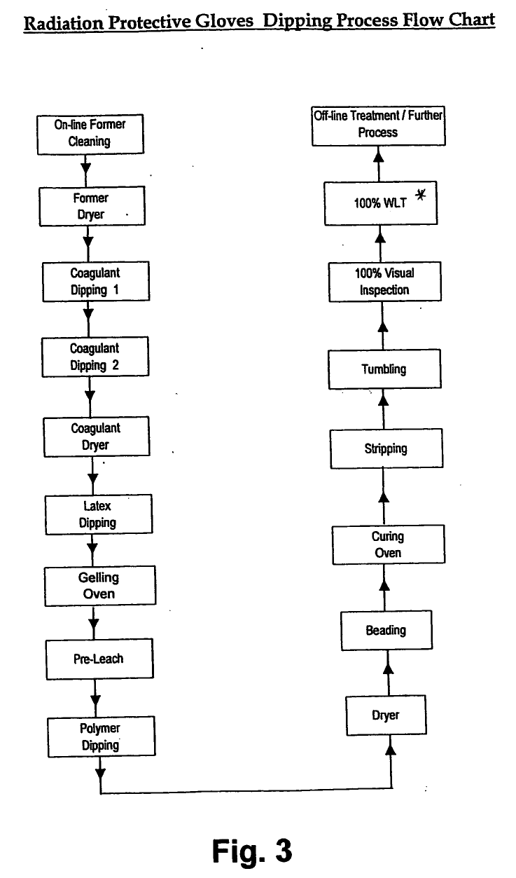

FIG. 3 illustrates a typical flow chart for the production of surgical radiation protection gloves, which are polymer coated on the donning side. The forms are first cleaned by dipping them successively into a solution of acid-based cleaner, followed by an alkaline based form cleaning agent. The forms are then brushed with rotating mechanical brushes followed by rinsing with clean hot water at about 70 to 80° C. to complete the cleaning. After cleaning, the formers are dried by circulating hot air in a former dryer at a temperature of about 50 to 100° C., e.g., for about 5 to 10 minutes. The formers are then dipped full length into coagulant 1 comprising about 30 to 40% calcium nitrate solution, which is then followed by dipping up to the wrist into a more dilute coagulant 2 comprising about 20 to 30% calcium nitrate solution. Typically, the dipped form is allowed to dry before being dipped into the second coagulant. This double coagulant dipping feature is used to ensure that the final glove produced will have uniform thickness from cuff to finger-tip.

After dipping the forms into the coagulant mixtures, they are dried in a coagulant dryer at a temperature of about 70 to 100° C. for about 5 to 10 minutes. Subsequent to drying, the forms are then dipped into the above described formulated latex dispersion, which is stirred continuously, but gently, and maintained at a temperature of about 20 to 30° C. The dwell time within the latex dispersion is about 5 seconds, while the down and up times are about 8 seconds each. The coated forms are then moved to a gelling oven where they are exposed to hot air having a temperature of about 70 to 100° C. for a time duration of about 5 minutes.

After the mixture has gelled on the formers, the coated formers undergo a pre-leaching process by immersing them in over-flowing, clean, hot water at a temperature of about 60 to 80° C. for about 3 minutes. When pre-leaching is complete, the coated formers are then dipped momentarily into a polymer coating solution maintained at a temperature of about 20 to 30° C. In this examples, the latex dispersion comprises a copolymer of acrylic acid and acrylic acid ester, and upon partial drying at a temperature of about 70 to 100° C. for about 3 minutes, will leave a thin polymer coating on the base glove. This polymer coating will be further bonded to the base glove upon subsequent curing of the whole glove to be described later. This polymer coating is very slick and has a relatively low surface friction with the human hands, which enables easy donning of the final formed glove without the need for any powder or other lubricating agents.

After partial drying, the polymer coated forms then undergo a beading process where the peripheral edges of the cuff openings of the dipped gloves are strengthened by rolling them into a solid bead (rubber band) of about 1 to 2 mm diameter. After the beading process is complete, the coated formers are then moved to a curing oven, which cures the beaded gloves by exposing them to recirculating hot air at a temperature of about 100° C. to 140° C. for about 60 to 100 minutes. When the gloves have cured, they are then manually stripped from the forms and further tumbled within a tumbler dryer at a temperature of about 70 to 90° C. for about 60 to 100 minutes to eliminate excessive powder and moisture from the gloves. This tumbling action also serves to complete curing of the gloves. The gloves thereafter undergo a 100% visual inspection for visual defects. This is followed by 100% water leak test (WLT) where the gloves are tested for pinholes/holes by filling each with about 1 liter of water and checking for leakages after about 2 minutes holding time.

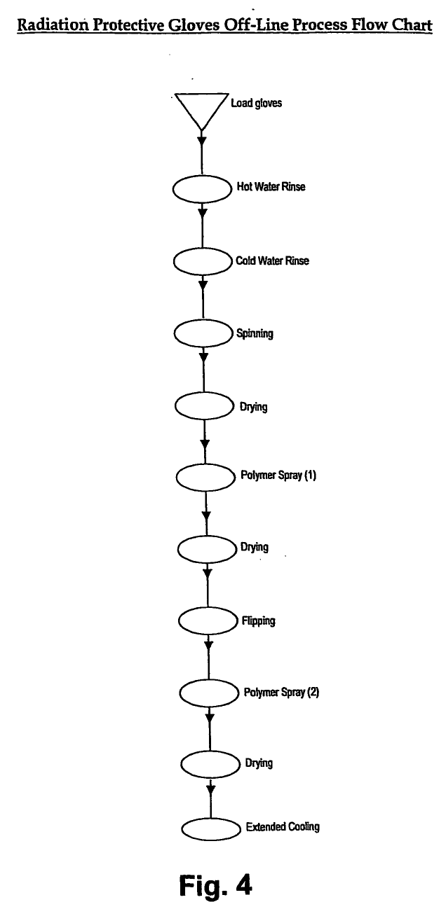

The formed gloves are further subjected to an off-line treatment/process as shown in FIG. 4, the purpose of which is to: i) convert these gloves from powdered to powder free; ii) further enhance donnability especially with damp hands; iii) impart desired “skin-grip” surface finish on working side; and iv) prevent the gloves from sticking together on both the donning and working side (after cuffing) upon storage after sterilization. In the first stage of this off-line treatment, the formed gloves are first washed batch-wise with hot water at about 60 to 90° C. for at least about 10 minutes to remove powder and non-rubbers, including proteins that are inherently present in the natural rubber from the PV latex. The gloves are then washed with unheated cold water (ambient temperature about 30° C.) for about 10 minutes. They are then spun at about 400 RPM for about 10 minutes to extract surface water before being partially dried in tumbler dryers at a temperature of about 60 to 80° C. for about 30 minutes.

After this first partial drying of the gloves with their working side outside, at least one layer of a polymer (1), which is a polyacrylate polymer, is sprayed on to the outer surface of the gloves to get the desired surface (grip) finish, to reduce a surface drag on the outer surface and also to prevent stickiness of the working side upon storage after sterilization. The gloves are dried further at about 60 to 80° C. for about 10 minutes before they are removed from the tumblers and flipped (turned inside out) to get the donning side outside and the working side inside. They are now returned to another tumbler dryer and dried at about 60 to 80° C. for at least about 30 more minutes. During this second drying, at least one layer of a polymer (2), which comprises a copolymer of an acrylic acid and an acrylic acid ester or which comprises a cationic-based surfactant, is sprayed in so as to coat the donning side uniformly to enhance the damp hand donnability of these gloves. After drying, the gloves are then cooled down to ambient temperature and then turned over (flipped) to get the correct configuration with the donning surface inside and the working surface outside. Finally, the gloves are pair-packed and sealed before being subjected to sterilization by gamma radiation like conventional surgical gloves.

The gloves, having radiation attenuating particles distributed therein, have the radiation attenuation characteristics, as measured according to DIN 6845/1 and IEC 1331-1/ICRP 60/ICRU 51, as shown in Table 5. DIN-6815-1 is a German Standard for the “Testing of materials for radiation protection against x-rays and Gamma-rays,” with DIN being an acronym for DEUTSCHE INDUSTRIE NORM (German Industrial Standard). EC 1331-1 (International Electro-technical Commission) is a standard of attenuation properties of materials. ICRP 60 is the 60th recommendation of the International Commission of Radiation Protection, which is the governing body on all radiation issues. ICRU 51 is the 51st recommendation of the International Commission of Units.

TABLE 5
ATTENTUATION TEST RESULTS OF RADIATION PROTECTION
GLOVES WITH THICKNESS 0.30 mm

| Material | | | | | | | | |
|---|---|---|---|---|---|---|---|---|
| | Dry | | | | | | | |
| | rubber | Radiation Absorbing | | | | Attenuation | | |
| | (% by | Particle (% by weight) | | | | Test Result | | |
| Sample | weight) | Bi₂O₃ | WO₃ | SnO | Sn | 60 kV | 80 Kv | 100 kV |
| 1 | 33.0 | 16.7 | — | — | 50.3 | 49% | 43% | 36% |
| 2 | 33.0 | — | 16.7 | 50.3 | — | 41% | 29% | 23% |
| 3 | 33.0 | 67.0 | — | — | — | 58% | 49% | 41% |
| 4 | 33.0 | 33.5 | 33.5 | — | — | 54% | 40% | 34% |
| 5 | 33.0 | — | 67.0 | — | — | 41% | 33% | 24% |
| 6 | 33.0 | 16.7 | 16.7 | 33.5 | — | 54% | 42% | 34% |
| 7 | 33.0 | 33.5 | — | — | 33.5 | 56% | 47% | 40% |
| 8 | 33.0 | — | — | 67.0 | — | 29% | 26% | 23% |

The examples that follow describe some of these gloves which showed a maximum reduction in the radiation dose from secondary X-rays at 60 and 100 kV intensity of about 58% (60 kV) and about 41% (100 kV) respectively at a glove thickness of 0.3 mm. The equivalent lead value lies between about 0.03 and 0.04 mm Pb.

### EXAMPLE 1

Glove comprising about 33% by dry weight natural rubber (NR) with about 16.7% bismuth oxide particles and about 50.3% metallic tin particles. At 0.3 mm glove thickness, attenuation at 60 kV, 80 kV and 100 kV are 49%, 43% and 36%, respectively.

### EXAMPLE 2

Glove comprising about 33% by dry weight natural rubber (NR) with about 16.7% tungsten oxide and about 50.3% tin oxide. At 0.3 mm glove thickness, attenuation at 60 kV, 80 kV and 100 kV are 41%, 29% and 23%, respectively.

### EXAMPLE 3

Glove comprising about 33% by dry weight natural rubber (NR) with about 67% bismuth oxide. At 0.3 mm glove thickness, attenuation at 60 kV, 80 kV and 100 kV are 58%, 49% and 41%, respectively.

### EXAMPLE 4

Glove comprising about 33% by dry weight natural rubber (NR) with about 33.5% bismuth oxide about 33.5% tungsten oxide. At 0.3 mm glove thickness, attenuation at 60 kV, 80 kV and 100 kV are 54%, 40% and 34%, respectively.

### EXAMPLE 5

Glove comprising about 33% by dry weight natural rubber (NR) with about 67% tungsten oxide. At 0.3 mm glove thickness, attenuation at 60 kV, 80 kV and 100 kV are 41%, 33% and 24%, respectively.

### EXAMPLE 6

Glove comprising about 33% by dry weight natural rubber (NR) with about 16.7% bismuth oxide, about 16.7% tungsten oxide and about 33.5% tin oxide. At 0.3 mm glove thickness, attenuation at 60 kV, 80 kV and 100 kV are 54%, 42% and 34%, respectively.

### EXAMPLE 7

Glove comprising about 33% by dry weight natural rubber (NR) with about 33.5% bismuth oxide and about 33.5% metallic tin. At 0.3 mm glove thickness, attenuation at 60 kV, 80 kV and 100 kV are 56%, 47% and 40%, respectively.

### EXAMPLE 8

Glove comprising about 33% by dry weight natural rubber (NR) with about 67% tin oxide. At 0.3 mm glove thickness, attenuation at 60 kV, 80 kV and 100 kV are 29%, 26% and 23%, respectively.

The foregoing description, examples and accompanying figures are illustrative of the present invention. Still other variations and are possible without departing from the spirit and scope of this invention.

What is claimed is:

1. A lead-free radiation protection material for use in radiation protection gloves to protect a wearer from secondary radiation, the material comprising: at least one layer of a polymeric latex having radiation absorbing particles and a water soluble polymeric thickener distributed therein, all of the radiation absorbing particles in the material being lead-free and consisting essentially of at least one lead-free heavy metal, at least one lead-free heavy metal oxide, or a combination thereof; the radiation absorbing particles having a particle size of less than about 10 μm and being dispersed within the latex at a concentration, by dry weight, sufficient for a sheet of the material having a thickness of about 0.3 mm to block at least about 30% of scattered secondary X-radiation at an intensity of about 60 kV and at least about 20% of scattered secondary X-radiation at an intensity of about 100 kV.

2. The radiation protection material of claim 1 wherein the at least one layer of polymeric latex comprises about 20 to 40% by dry weight of rubber and about 60 to 80% by dry weight of radiation absorbing particles.

3. The radiation protection material of claim 2 wherein the thickener is present in the latex in an amount in the range of about 0.1 to 0.4% on a dry weight basis.

4. The radiation protection material of claim 1 wherein the thickener comprises a water-soluble cellulose ether.

5. The radiation protection material of claim 1 wherein the radiation absorbing particles consist essentially of at least one heavy metal oxide selected from the group consisting of bismuth oxide, tungsten oxide, tin oxide, and antimony-tin oxide, and a combination thereof.

6. The radiation protection material of claim 1 wherein the polymeric latex comprises a rubber material.

7. The radiation protection material of claim 6 wherein the rubber material is selected from the group consisting of polyisoprene rubber, polybutadiene rubber, styrene-butadiene rubber, nitrile rubber, butyl rubber, ethylene-propylene rubber, neoprene rubber, silicone rubber, polysulfide rubber, and urethane rubber.

8. The radiation protection material of claim 1 wherein the latex material comprises a natural rubber latex.

9. The radiation protection material of claim 8 wherein the natural rubber latex is a pre-vulcanized natural rubber latex.

11. A lead-free radiation protection glove for protecting a wearer from scattered secondary radiation, the glove having an inner skin contacting surface and an outer surface and comprising: at least one layer of a rubber latex having radiation absorbing particles and a water soluble polymeric thickener distributed therein, all of the radiation absorbing particles in the glove being lead-free and consisting essentially of at least one lead-free heavy metal, at least one lead-free heavy metal oxide, or a combination thereof, the radiation absorbing particles having a particle size of less than about 10 μm and being dispersed within the latex at a concentration, by dry weight, sufficient for a glove having a thickness of about 0.3 mm to block at least about 30% of scattered secondary X-radiation at an intensity of about 60 kV and at least about 20% of scattered secondary X-radiation at an intensity of about 100 kV.

12. The radiation protection glove of claim 11 further comprising at least one layer of a polymer coating on the inner skin-contacting surface thereof, which reduces a surface friction of the inner surface with respect to hands.

13. The radiation protection glove of claim 11 wherein the at least one layer of polymer coating comprises a copolymer of an acrylic acid and an acrylic acid ester.

14. The radiation protection glove of claim 11 wherein the inner skin-contacting surface includes a coating of a cationic-based surfactant to improve the lubricity and donnability of the glove with respect to damp hands.

15. The radiation protection glove of claim 14 wherein the at least one layer of rubber latex comprises about 20 to 40% by dry weight of rubber and about 60 to 80% by dry weight of radiation absorbing particles.

16. The radiation protection glove of claim 15 wherein the thickener is present in the latex in an amount in the range of about 0.1 to 0.4% on a dry weight basis.

17. The radiation protection glove of claim 11 wherein the thickener comprises a water-soluble cellulose ether.

18. The radiation protection glove of claim 11 wherein the radiation absorbing particles consist essentially of a heavy metal oxide selected from the group consisting of bismuth oxide, tungsten oxide, tin oxide, and antimony-tin oxide, and a combination thereof.

19. The radiation protection glove of claim 11 wherein the radiation absorbing particles consist essentially of:
about 60 to 90% by weight of particles selected from the group consisting of metallic tin particles, tin oxide particles, antimony-tin oxide particles; and
about 10 to 40% by weight of particles of an oxide selected from the group consisting of bismuth oxide and tungsten oxide.

20. The radiation protection glove of claim 11 wherein the radiation absorbing particles have a particle size of less than about 6 μm.

21. The radiation protection glove of claim 11 wherein the radiation absorbing particles have a particle size of less than about 2 μm.

22. The radiation protection glove of claim 11 wherein the radiation absorbing particles are present at a concentration sufficient for a sheet having a thickness of about 0.3 mm to block at least about 50% of scattered secondary X-radiation at an intensity of about 60 kV and at least about 30% of scattered secondary X-radiation at an intensity of about 100 kV.
